(19) United States
(12) Patent Application Publication
(10) Pub. No.: US 2005/0182721 A1
(43) Pub. Date: Aug. 18, 2005

(54) Remittance information processing system

(76) Inventor: Gershon Weintraub, Brooklyn, NY (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/058,813

(22) Filed: Feb. 16, 2005

Related U.S. Application Data
(60) Provisional application No. 60/545,112, filed on Feb. 17, 2004.

(51) Int. Cl. G06F 17/60

(52) U.S. Cl. 705/40; 705/30

(57) ABSTRACT

A system for processing remittance information identifying a payment made for provision of healthcare services includes an interface for receiving data representing information identifying a received remittance. A data processor parses the received data representing information identifying a received remittance to identify and correct irregularities in the remittance information using predetermined rules. The data processor provides processed remittance information for storage in a remittance repository. The remittance repository stores remittance information identifying payments made for provision of healthcare services to patients. A command processor automatically initiates generation of a claim to a third party payer in response to the processed remittance information.

The present application derives priority from provisional patent application Ser. No. 60/545,112, filed on Feb. 17, 2004.

### FIELD OF THE INVENTION

This invention relates generally to the field of data processing, and more specifically to computer systems that facilitate the storage and communication of payment information within a multiple entity healthcare environment.

### BACKGROUND OF THE INVENTION

A healthcare facility generates an invoice or bill after furnishing medical services to a patient. Payment is ultimately received from the patient, a guarantor and/or an insurer. The typical multiple entity healthcare enterprise utilizes an integrated data processing system to generate each invoice in response to the provision of services, and to monitor the progress of collecting a complete and timely payment. Existing payment monitoring systems post or record data related to the payments received in a system receivables file and do not maintain the original remittance information identifying the payments for possible subsequent use. Such remittance information is thus no longer available in its original, unaltered form for later review and attachment to subsequent bills. Remittance transaction information is irretrievably lost once data related to the payments is posted. In some existing systems remittance data is sometimes lost when an erroneous bill is cancelled and then recalculated.

Because remittance transaction information identifying a payment is lost, if there is an error in posting the payment, current systems have difficulty in reposting the transaction after system files have been corrected to eliminate the error. There exists a need to avoid requiring duplicate remittance data entry in a data processing system when data related to the identified payment is accidentally posted more than once. A need, thus, exists to retain the original remittance data in a manner that will permit ready access to other users and applications during subsequent remittance processing activities that may occur.

### BRIEF SUMMARY OF THE INVENTION

In accordance with principles of the present invention, a system for processing remittance information identifying a payment made for provision of healthcare services includes an interface for receiving data representing information identifying a received remittance. A data processor parses the received data representing information identifying a received remittance to identify and correct irregularities in the remittance information using predetermined rules. The data processor provides processed remittance information for storage in a remittance repository. The remittance repository stores remittance information identifying payments made for provision of healthcare services to patients. A command processor automatically initiates generation of a claim to a third party payer in response to the processed remittance information.

### BRIEF DESCRIPTION OF THE DRAWING

In the drawing:

FIG. 1 is a block diagram of a remittance information processing system according to the principles of the present invention;

FIG. 2 is an exemplary outpatient registration list that is a feature of the system illustrated in FIG. 1;

FIG. 3 is an exemplary display of remittance files associated with an outpatient identified in FIG. 2;

FIG. 4 is an exemplary list of remittance information associated with a remittance file identified in FIG. 3;

FIG. 5 is an exemplary remittance detail selected from the list of remittance information illustrated in FIG. 4;

FIG. 6 is an exemplary display that lists profiles associated with patients for whom remittances are submitted for processing by the present invention;

FIG. 7 is an exemplary display of available rules to be applied to the processing of a remittance according to the principles of the present invention;

FIG. 8 is an exemplary display of the selected rule specification illustrated in FIG. 7;

FIG. 9 is an exemplary display of a remittance detail after application of the rule illustrated in FIG. 8;

FIG. 10a illustrates a flowchart describing the operation of the system illustrated in FIG. 1 to implement automatic secondary billing; and

FIG. 10b illustrates a flowchart describing the operation of the system illustrated in FIG. 1 to implement automatic adjustment billing.

### DETAILED DESCRIPTION OF THE INVENTION

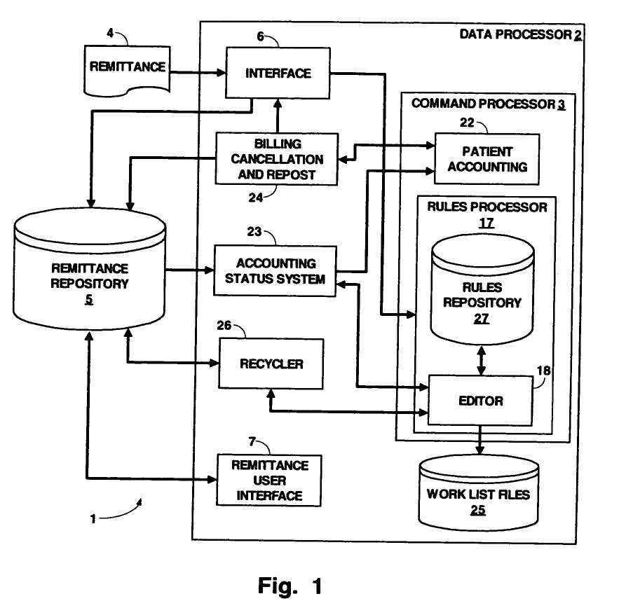

FIG. 1 is a block diagram depicting the major components of a system 1 used for processing remittance data. The system 1 is implemented via a data processor 2. As used herein, a data processor operates under the control of an executable application to (a) receive information from an input information device, (b) process the information by manipulating, analyzing, modifying, converting and/or transmitting the information, and/or (c) route the information to an output information device. A data processor may use, or comprise the capabilities of, a controller or microprocessor, for example. The data processor may operate with a display processor or generator. A display processor or generator is a known element for generating signals representing display images or portions thereof. A data processor and a display processor comprises any combination f, hardware, firmware, and/or software.

An executable application as used herein comprises code or machine readable instructions for conditioning the data processor to implement predetermined functions, such as those of an operating system, healthcare information system or other information processing system, for example, in response user command or input. An executable procedure is a segment of code or machine readable instruction, sub-routine, or other distinct section of code or portion of an executable application for performing one or more particular processes. These processes may include receiving input data and/or parameters, performing operations on received input data or performing functions in response to received input parameters, and providing resulting output data and/or parameters. A user interface comprises one or more display images, generated by the display processor under the control of the data processor, enabling user interaction with a processor or other device.

In the illustrated embodiment, the command processor 3 is implemented as an executable application executing on the data processor 2. Thus, the command processor 3 conditions the data processor 2 to operate in the manner described below. One skilled in the art understands that the data processor 2 and command processor 3 may comprise any combination of, hardware, firmware, and/or software.

The command processor 3 examines encounter related information as it is generated, communicated and stored. As used herein, an encounter is a meeting or interaction between a patient and one or more healthcare providers, for the purpose of receiving one or more health related services. Such encounters have a financial or transaction consequence. While most encounters are in person (e.g. doctor visit, hospital admission), encounters could also occur remotely, as in a telephone conversation (e.g. phone call to physician) or an electronic exchange (e.g. email). The command processor 3 examines encounter related records, messages and/or stored data associated with: orders for medical services, procedures, test results, laboratory results, billing and claim data, patient records and associated diagnosis, treatment, medication and protocol notes and codes.

The command processor 3 also calculates the charge for the provision of the healthcare services. As used herein, a charge is a dollar amount associated with performed services. The command processor 3 produces a claim for payment from a third party payer. As used herein, a third party payer is an organization which pays for or underwrites coverage for healthcare expenses. A third party payer may be the government (for example, Medicare and Medicaid), a nonprofit organization (such as Blue Cross/Blue Shield), a commercial insurance (such as Cigna), or some other organization. As used herein, a claim is a demand for a sum of money due from a third party payer for one or more services rendered. The generation and transmission of such a claim is not germane to the present invention, and will not be described in detail.

In response to receipt of a claim, a third party payer analyzes the contents of the claim to determine if they are liable and to determine what reimbursement the healthcare provider is entitled to. As used herein, reimbursement is the monetary compensation that a healthcare provider receives from a third party payer as consideration for providing services to patients. The third party payer provides the reimbursement to the healthcare provider via a remittance. The remittance includes information identifying the claim with which the reimbursement is related, the amount of the reimbursement, and other data related to the reimbursement.

Typically, a third party payer is not liable for the total charge for provision of medical services. In such cases, more than one third party payer may be sent respective claims in a predetermined order. The respective third party payers may send corresponding reimbursements via associated remittances to the healthcare provider. When no further third party payers are liable, then a guarantor is sent a bill for the portion of the charge for provision of healthcare services which remains unpaid. As used herein a guarantor is a person or organization who promises to pay, or guarantees payment, for that portion of the patient's health related services that are not covered by third party payers. A guarantor may be the patient, a relative, a friend, an employer, a court, a trust, etc. In general, a claim does not create an absolute expectation of payment, while a bill is an expectation of payment. In response to receipt of a bill, the guarantor sends a final reimbursement to the healthcare provider.

The system 1 is adapted for processing remittance information identifying a payment made for provision of healthcare services. Data representing information identifying a remittance 4 is received, e.g. from a third party payer, by an interface 6. The command processor 3 parses the received data representing information identifying a received remittance to identify and correct irregularities in the remittance information using predetermined rules, thus providing processed remittance information. The processed remittance information is forwarded to a remittance repository 5 which stores the information identifying payments made for provision of healthcare services to patients. A command processor 3 automatically initiates generation of a claim to a subsequent third party payer, or a bill to a guarantor, in response to the processed remittance information.

The remittance information 4 is received in a format that permits integration into the remainder of the system 1. The remittance information 4 may represent payment for a whole healthcare claim or a portion of a healthcare claim associated with an individual patient encounter with a healthcare service provider, as described above. The remittance information 4 includes an identifier identifying an associated healthcare claim and one or more of: (a) an associated patient identifier, (b) associated healthcare encounter identification information, (c) an associated healthcare insurance plan identifier, (d) a payer organization identifier and/or (e) a healthcare provider organization identifier. The command processor 3 uses the accumulated remittance information to determine whether a second bill, for a subsequent third party payer or guarantor, is to be generated associated with the healthcare claim.

The command processor 3 identifies an irregularity in the remittance information 4 by applying one or more predetermined rules, as described above. A rules processor 17 applies the predetermined rules to the various data in the remittance information 4, either separately or in combination, to determine if the remittance information 4 is in accordance with the rules; and if an irregularity is found, what the nature of the irregularity is, what corrective action may be performed and/or whether an error condition is generated. The rules are derived based one or more of: (a) documentation and/or (b) other information provided by healthcare payer institutions. An individual rule of the predetermined rules may contain at least one test used to identify a true or false condition. A rule may also contain a combination of tests with individual test results being logically combined to provide an overall true or false result. The rules processor 17 initiates a first action in response to a true condition and a second action in response to a false condition. The predetermined rules are stored in a rules repository 27. The rules repository 27 may associate a time period of validity with an individual rule. The command processor 3 examines the rule validity period and does not apply a rule at a time and date falling outside of the rule validity period.

If the command processor 3 identifies an irregularity in the remittance information 4 which cannot be corrected, or possibly even if it can be corrected, it may produce an indication of an error condition. In response, the command processor 3 may automatically initiate generation of a message alerting a user to the error condition identified by the command processor 3 in the data representing information identifying the received remittance 4. The command processor 3 may also automatically schedule a worker to review the error condition identified by the command processor 3 in the data representing information identifying the received remittance 4. The command processor 3 may place an entry in a work list file 25 which contains information specifying the nature of the error condition and the entry in the remittance repository 5 containing the received remittance 4.

A more detailed description of the system 1 in FIG. 1 follows. The accounting status system 23 retrieves data contained in the remittance repository 5 to determine the status of the retrieved remittance; for example, whether the remittance is remitted (i.e. newly received), is ready to post (i.e. the remittance information has been checked and verified and is ready to be applied to a patient account), or is posted (i.e. applied to a patient account). The patient accounting system 22 processes the retrieved remittance 4, in the appropriate manner depending on its status. For example, if the status of the remittance 4 indicates that it is remitted, then the data representing the remittance 4 is processed by the rules processor 17 to detect and possibly to correct any errors. If the status of the remittance 4 indicates that it is ready to be posted (i.e. it is checked and verified), the patient accounting system 22 posts the remittance 4 by applying the payment and/or adjustment identified by the remittance information to the patient account.

The command processor 3 also includes a remittance recycler 26 which inspects information representing remittances 4 present in the remittance repository 5, identifying those remittances 4 that are duplicates or that should be forwarded to an editor module 18, to be prepared for use by other system files. The editor 18 determines whether any particular data item is needed by or is ready to be sent to another application or location, such as the patient accounting system 22. The editor 18 further parses the data representing information identifying a received remittance to identify irregularities in remittance information using predetermined rules stored in a rules repository 27. The editor 18 also automatically modifies remittance data to correct identified irregularities and/or enters data representing unprocessed remittances to a worklist file 25, as warranted.

The remittance repository 5 is capable of permanently storing remittance information in its original form and is structured to include corresponding claim line items that are accessible to a system user via a remittance user interface 7. There are three types or levels of remittances, namely the least detailed claim level, the claim line level, and the most detailed charge level. This categorization reflects how the third party payer or guarantor remits and how the healthcare provider wishes to receive and post the remittance. The present system 1 may use remittance information at any of these levels. For example, the illustrated system 1 processes and utilizes charge level and/or claim line level information associated with a payment from a third party payer both to automatically generate adjustment claims to the same payer, in the case of appeals or additional late charges, and to automatically generate secondary claims to the next available provider of payment coverage. Editing and correction may be done at the claim line level where line items are the informational units used to create additional bills that may be required.

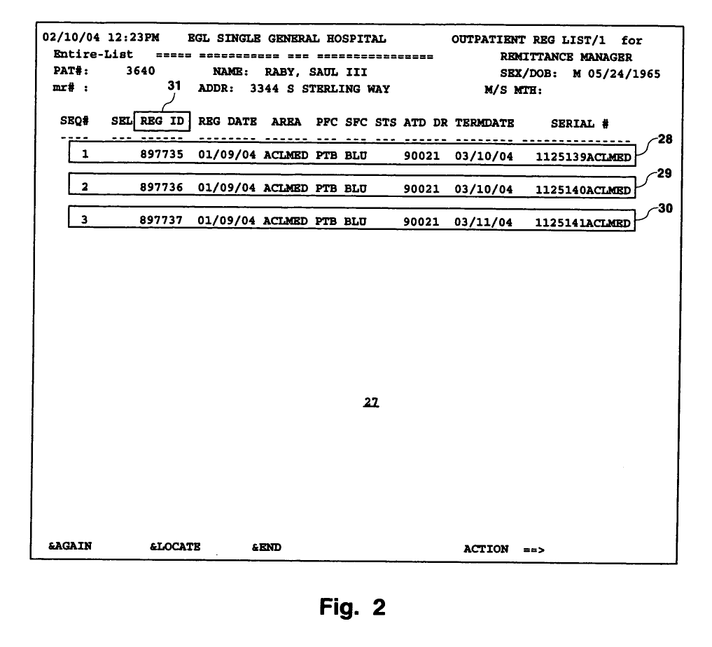

As may be seen in FIG. 1, user access to the system 1 is achieved via the remittance user interface 7. Referring to FIG. 2, the remittance user interface 7 conditions the display processor (not shown) of the system 1 to display an image 27 listing, for example, one or more patient registrations 28, 29 and 30. A patient registration is assigned a unique serial number, illustrated in column 31. A user selects a particular registration by any of several known selection methods, for example a user may type the sequence number assigned to the desired registration at the ACTION prompt in the lower right portion of the image 27.

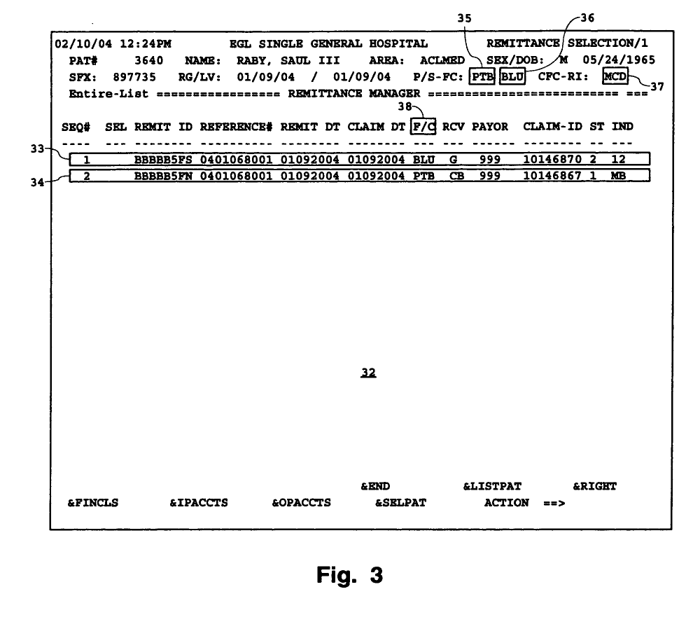

By selecting a particular registration, such as registration 28 (e.g. SEQ# 1), for example, the system user is presented with the display image 32 shown in FIG. 3 listing the received remittances associated with that patient. Display image 32 shows the remittances 33 and 34 that have been received by interface 6 (FIG. 1) for the particular registration 28 (FIG. 2). The display image 32 indicates in field 35 the identity of the primary insurer, in field 36 the identity of the secondary insurer and in field 37 the identity of the tertiary insurer. In this particular example, the primary insurer is Medicare Part B (represented by the code PTB), the secondary insurer is Blue Cross (represented as BLU) and the tertiary insurer is Medicaid (represented as MCD). In this example a claim has been submitted to two of the insurers, Medicare Part B and Blue Cross. Remittances, represented by lines 34 and 33 respectively, have been received from both of them. Column 38 indicates that the remittance 33 was received from Blue Cross and the remittance 34 was received from Medicare Part B. The user is able to select one of the remittances 33 and 34 for further inspection e.g. by typing the sequence number of the desired remittance in the ACTION prompt at the lower right of the display image 37.

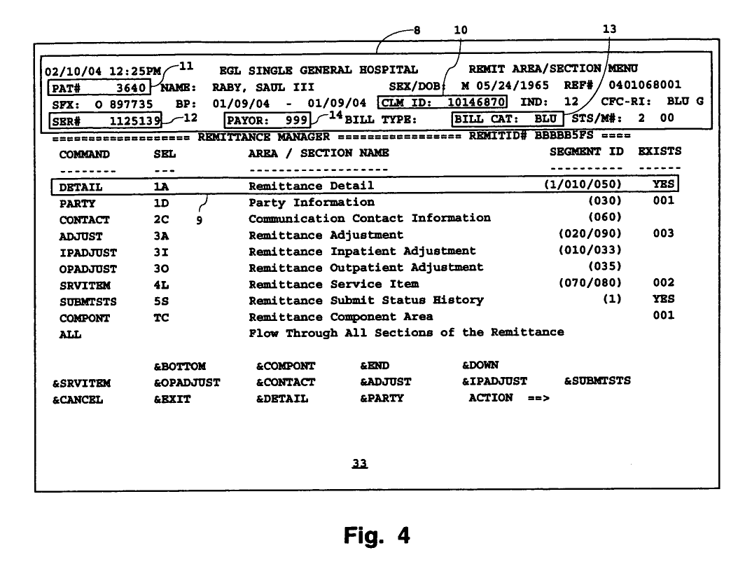

Referring to FIG. 4, information is displayed representing an individual remittance advice or document 33 selected by the user via the display 32 (FIG. 3). The information representing the remittance advice 33 is permanently stored in the remittance repository 5 (FIG. 1) as a file containing a plurality of records. The remittance file includes a single header record containing data representing a set of identification information, illustrated in FIG. 4 by information displayed in area 8. The header or identifier information 8 includes an associated healthcare claim identifier (field 10), an associated patient identifier (field 11), associated healthcare encounter identifier (field 12), an associated healthcare insurance plan identifier (field 13), and a third party payer organization identifier (field 14). In FIG. 4, the selected remittance 33 indicates that the health insurer 13 is Blue Cross (BLU). Other identification information may also be included in the header record 8, such as healthcare provider organization identifier (not shown). The header records 8 are indexed so as to enable high speed searches by a variety of identification criteria. The remittance file also includes one or more detail records 9 containing transaction data, e.g. line item information, represented by information displayed in the lower portion of FIG. 4. The user may elect to view the information in the detail records by e.g. typing a “D” at the action prompt at the bottom right hand side of the image.

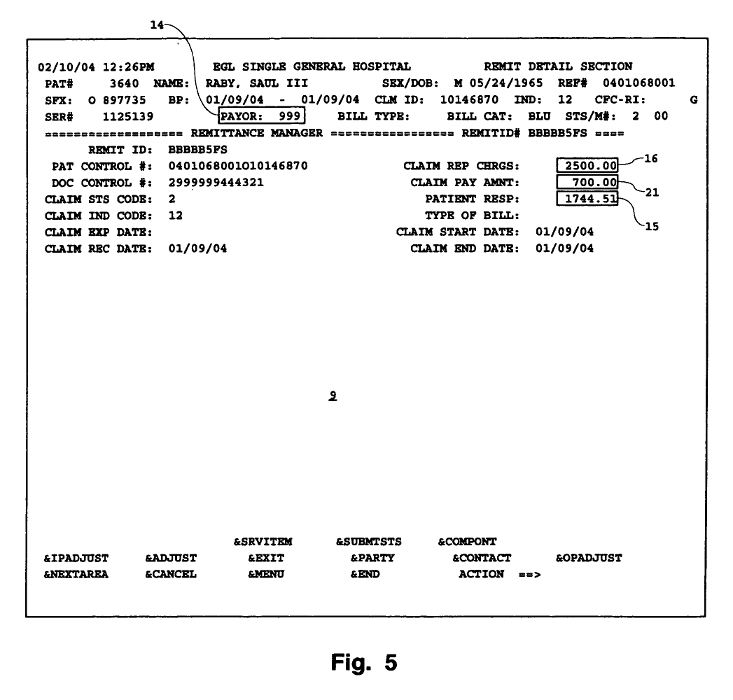

In FIG. 5, an image of the detailed line item information 9 for the remittance advice 33 (FIG. 4) illustrates multiple data fields, some of which occur only once per remittance advice 33, such as, for example, the data field 14 containing the code identifying the third party payer which submitted the remittance advice 33. There are other data fields which may have multiple occurrences within one remittance advice 33. For example, although only one line item charge data field is illustrated (e.g. data field 16) more than one line item charge may be submitted to the third party payer, thus, more than one line item charge data field may be present in the remittance advice 33. Some of the detail data fields which may have multiple occurrences are associated with a given occurrence of data residing in another data field, such as, for example, line item payment data field 21. A line item payment date field 21 is present for each line item charge date field 16.

In the illustrated example, the line item charge data field 16 for services rendered to the patient contains the value 2500.00 (representing $2,500.00). The payment amount data field 21, i.e. the amount the third party payer Blue Cross is paying, contains the value 700.00 ($700.00). The third party payer (Blue Cross) estimates that the patient responsibility for these charges is $1,744.51. The corresponding patient responsibility data field 15, thus, contains the value 1744.51 ($1,744.51). The detail records 9 represent a transcription of the information in the remittance advice 33 (FIG. 4) received from the third party payer. However, because this third party payer (Blue Cross) does not have access to the information associated with the patient, and in particular to the associated third party payers, there is no guarantee that the remittance information, e.g. the patient responsibility portion 15, is correct. In the illustrated example, the primary insurer Medicare Part B is to pay, or has already paid, $1,744.51 while the remaining amount of $55.49 is to be billed to the tertiary insurer, Medicaid. The Blue Cross detail records 9 incorrectly lists the primary insurer (Medicare Part B) claim amount as the patient responsibility. In other words, a secondary insurer such as Blue Cross, for example, may on occasion generate and submit a remittance advice which erroneously places the amount of the claim submitted to the primary insurer (Medicare Part B) in the patient responsibility data field 15.

Referring again to FIG. 1, the error appearing in the data field 15 (FIG. 5) may be automatically detected and corrected by a rules processor 17. The command processor 3 includes the rules processor 17 which uses rules stored in a rules repository 27, user specified logic, and patient data to automatically detect and correct data errors in a remittance 4. The rules processor 17 applies a set of rules specifying allowable relationships for data in the remittance 4. Application of one or more rules in the set of rules may result in the detection of an error in the acquired data representing information identifying the received remittance 4. In response to the detection of an error, the rules processor 17 may automatically initiate generation of an alert message notifying a user of the existence of the error condition identified by the rules processor 17. The command processor 3 may also automatically schedule a worker to review the error condition in the acquired data representing information identifying the received remittance 4 identified by the rules processor 17 by placing an entry in a work list file 25.

A rule is a procedure for determining whether submitted healthcare remittance information complies with predetermined requirements including health plan reimbursement conditions, health plan format requirements, reimbursement formulae, reimbursement constraints and reimbursement computation procedures. A rule may also include a prescribed guide, precept or model which specifies the presentation, conduct or regulation of an action to be performed upon the form and its associated data, or the rule may define the relationship between the form and its associated data.

Healthcare institutions process electronic remittance information received from a diverse set of sources. This information is supposed to be supplied according to regulations specifying a standard format and protocol, but often the information as supplied violates the relevant regulations. The violations often cause processing to be halted or, more problematically, to continue in an incorrect and potentially data destroying fashion. The rules processor 17 detects errors in the data and causes the remittance information to be automatically modified and conformed according to the applicable rules so that the corrected information is available when needed for further remittance processing. Rules may apply to individual data fields and specify whether a data field needs to contain a value, or a nonzero value, and define the acceptable format or the set of acceptable values for the relevant data field. Rules may also apply to two or more data fields and specify relationships between data values in those data fields, e.g. if city and state data fields have values, then a postal zip code is expected to also have a value, and that value is checked to verify that it corresponds to the city and state.

The rules may be validated by the editor module 18 which applies a profile containing an indicator associated with a rule. The indicator specifies a user defined severity, and/or an action to be taken, when the rule is violated. The set of rules specify these indicators for an individual type 13 and payer 14 (FIG. 4) of claims and remittances 4. Custom user defined rules may use macro language executable procedures that allow a user to complement a standard set of rules with custom rules that are expressed using programming logic. The remittances 4 may be corrected using macro language executable procedures, for example, implementing user defined validation rules to perform automatic data correction expressed in programming logic.

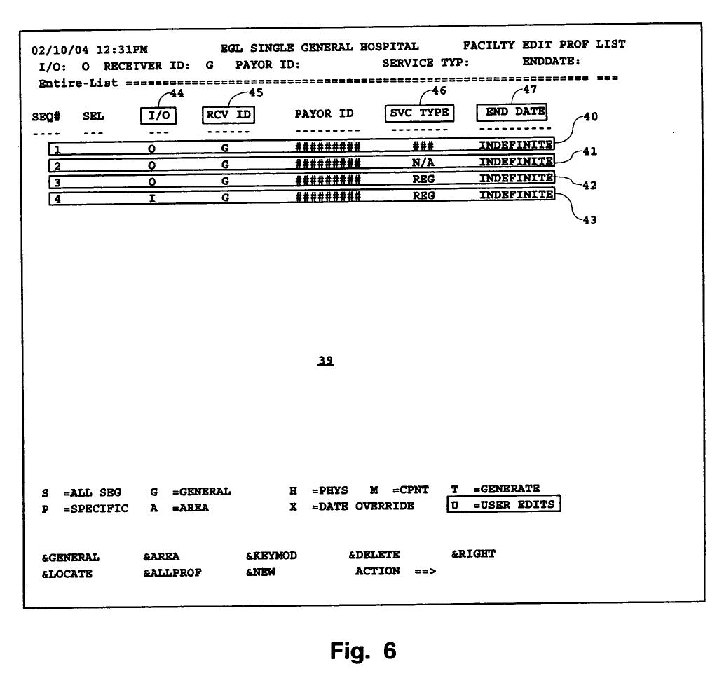

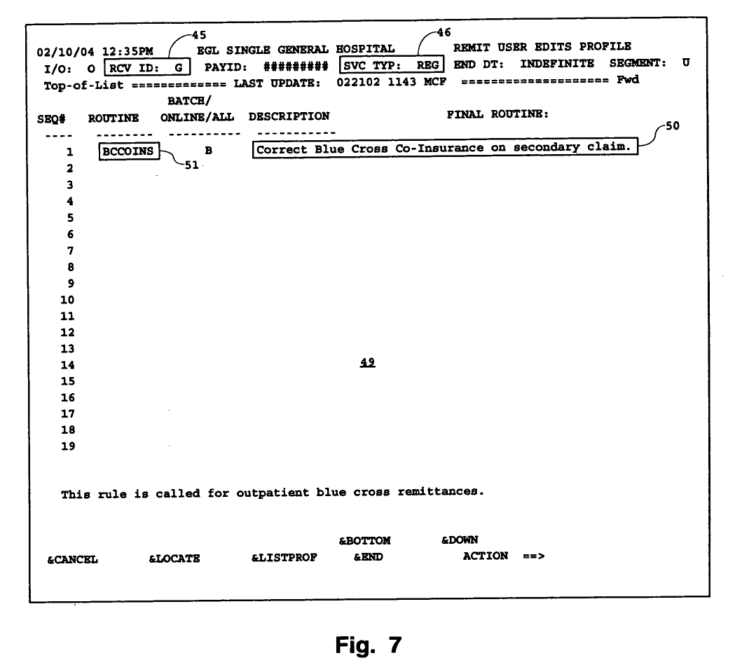

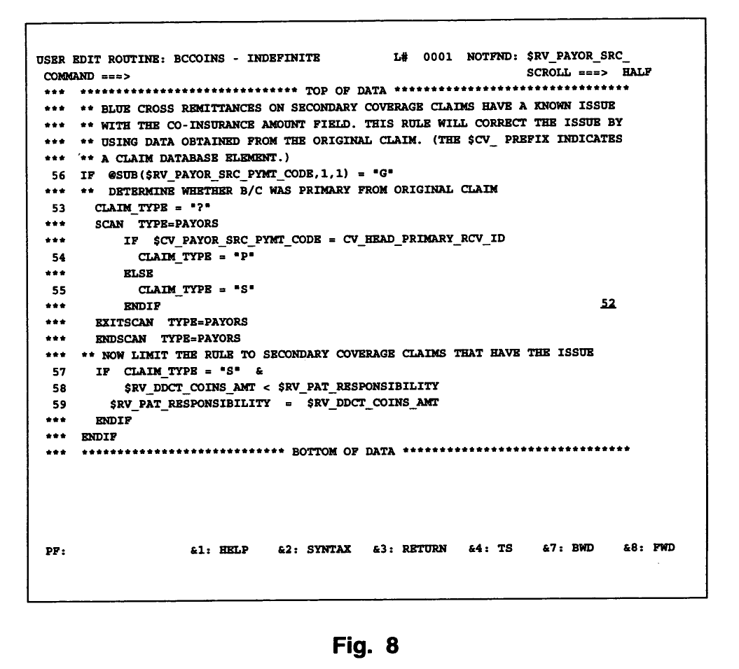

The rules may be more fully appreciated by reference to FIG. 6, FIG. 7 and FIG. 8. FIG. 6 illustrates a display image 39 that permits a system user to access a series of profiles: 40, 41, 42 and 43, for example. Column 44 indicates the type of patient to which the profile applies, with “0” indicating an outpatient and “I” indicating an inpatient. The receiver identification code data field 45 is associated with the particular insurer to which a claim has been sent, and in this example the data field 45 contains the value “G”. The service type column 46 indicates the category of service provided to a patient and the end date column 47 indicates when a particular patient profile will expire. The rules processor 17 (FIG. 1) examines the end date 47 and does not retrieve a rule at a time and date falling outside of the rule validity period, e.g. after the end date 47. One of the profiles 40, 41, 42, 43 may be selected by a user by typing the sequence number (SEQ#) for the desired profile at the action prompt at the bottom right of the display image 39. To continue the present example, a user selects profile 42.

FIG. 7 illustrates a display image 49 that appears in response to the selection of the profile 42 (FIG. 6). Display 49 lists the rules that have been defined for the profile 42. In this particular case, only a single rule, with the label 50, has been defined. The identifier 51 for the rule 50 is, in this example, BCCOINS. The rule 50 is automatically invoked for any outpatient remittance in which the receiver identifier field 45 is filled with the letter “G” and the service type field 46 is filled with the letters “REG”. This criterion is satisfied by the remittance 33 (FIG. 4), and would be satisfied, for example, by any typical outpatient Blue Cross remittance.

FIG. 8 illustrates a listing of the actual description or specification 52 of the rule 50. The specification 52 may be written in any computer readable language designed for that purpose, and the listing shown is only exemplary. The rules processor 17 (FIG. 1) is conditioned to process data as directed by the instructions provided by the specification 52. Line 56 of specification 52 conditions the rules processor 17 to determine if the first character of the receiver payer source payment code data field ($RV PAYER_SRC_PYMT_CODE), which is stored in the remittance repository 5 and which contains the receiver identification value 45, has a value of “G”. In other words, a true or false examination is made to determine if the receiver identification value 45 is “G”. If it is not, then no further processing is performed for this rule.

If it is, then further data in the remittance 4 is examined to determine the type of the claim: either a claim to a primary insurer (e.g. 35 of FIG. 3) or to a secondary insurer (e.g. 36 of FIG. 3). Line 53 initializes the claim type variable (CLAIM_TYPE) to “?”. Line 54 of the specification 52 sets the claim type variable to “P” for a primary insurer, if the data indicates that the claim related to the remittance 4 is to a primary insurer, while line 55 sets the claim type variable to “S”, for a secondary insurer, otherwise. In other words, true or false determinations are made based on data in the remittance 4 in order to determine the claim type. Lines 57, 58 and 59 of the rule specification 52 specify that if the claim type is “S”, signifying that the remittance was received from a secondary insurer, and the patient responsibility amount ($RV_PAT_RESPONSIBILITY) returned in the remittance 4 is greater than the patient coinsurance amount ($RV_DDCT_COINS_AMT), i.e. the amount that the primary insurer (Medicare Part B) will not pay, then the patient responsibility data field 15 (FIG. 5) is set to the patient coinsurance amount. In the present example, the primary insurer pays $1,744.51 of the $1,800.00 remaining after Blue Cross remitted $700.00. The patient coinsurance amount that the primary insurer will not pay (and hence is the patient responsibility 15) is $55.49. This amount is stored in the variable containing the amount which is the patient responsibility 15. The routine illustrated in FIG. 8 is performed automatically by the rules processor 17 (FIG. 1).

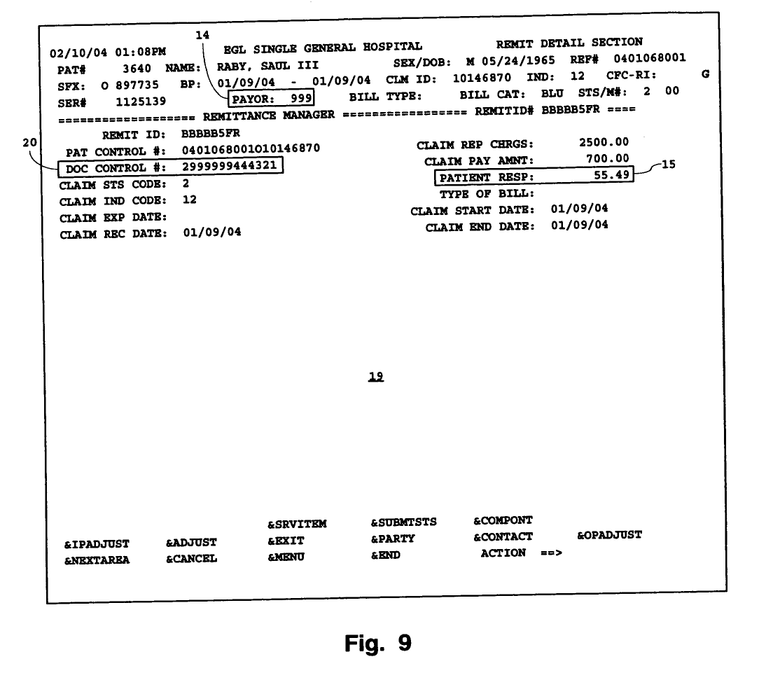

In FIG. 9, a display image 19 is illustrated which depicts the remittance detail after payment by payer 14 has been made and after application of the rule 50 (FIG. 7 and FIG. 8) detects and corrects the incorrect value of the patient responsibility amount 15 (FIG. 9) in the received remittance 4. In FIG. 9, the patient responsibility data field 15 contains “55.49” representing the correct patient responsibility payment of $55.49.

The display image 19 also includes a data element 20 identified as the document control number. The document control number 20 is provided on the remittance advice 4 and represents a unique identification number that the payer 14 has assigned to the claim. When the claim needs to be adjusted or replaced, or a late charge line item is to be added, an adjusted or replacement claim is submitted to the third party payer and the document control number 20 of the original processed claim is included in the adjusted or replacement claim.

Referring to FIG. 1, the typical patient accounting system 22, used by a multiple entity healthcare facility, creates a claim that lists services provided by a hospital or other healthcare organization to outpatients as line items. The services provided are associated with a standardized code which identifies the services to insurers, e.g. including Medicare. The code is typically based on the Healthcare Common Procedure Coding System (HCPCS). The HCPCS is based on the American Medical Association's Current Procedural Terminology (CPT). HCPCS includes three levels of codes. Level One consists of the CPT and is numeric. Level Two codes are alphanumeric and primarily include services not provided by a physician such as an ambulance service. Level Three consists of local codes used by state Medicaid agencies. The healthcare organization billing system processes these HCPCS codes and groups them under a different series of codes, specified by Medicare, called ambulatory payment classification (APC) codes. Several HCPCS codes may be aggregated into a single APC code. For example, there are separate HCPCS codes for a procedure and use of the recovery room following the procedure. The use of the recovery room is ancillary to the procedure, and so is classified with the procedure into a single APC code. Medicare has, for each APC code, a Medicare payment amount and a patient co-insurance amount. The payment amount is what Medicare will pay to the provider of the services encompassed by the APC code, and the co-insurance amount is the remainder of the bill that the patient either pays directly or forwards to additional, secondary insurers for payment. The healthcare organization patient accounting system 22 programming includes the respective Medicare and co-insurance payment amounts associated with each APC code. Many Medicare patients are also covered by Medicaid. For such patients, the billing system 22 concurrently creates a claim to be forwarded to Medicare and a claim to be submitted to Medicaid, billing the anticipated co-insurance amounts as appropriate for the various APC codes.

Secondary billing, that is billing of a subsequent third party payer, may be automatically performed, using validation rules in the rules repository 27, in response to the processing of a remittance 4 from a prior third party payer. More specifically, when more than one third party payer is available for a patient, a claim is first sent to the primary payer. After the primary third party payer submits payment through a remittance, a claim is sent to the secondary third party payer, and so forth. Claims that are sent to a secondary third party provider usually include data from the remittance 4 from the primary third party provider. One typical datum is the amount 21 (FIG. 5) paid by the primary party payer 14. Logic specified in a profile (40, 41, 42, 43 of FIG. 6) and/or a rule (52 of FIG. 7 or FIG. 8) is used to access the remittance repository 5 to retrieve data in the remittance 4 from the primary payer 14. This data is then processed to populate data fields needed by the patient accounting system 22 (FIG. 1) to create a claim for the secondary third party provider. If the remittance advice 4 from the primary payer 14 has not yet been received, these fields are not populated and a validation rule prevents the claim to the secondary third party payer from being submitted.

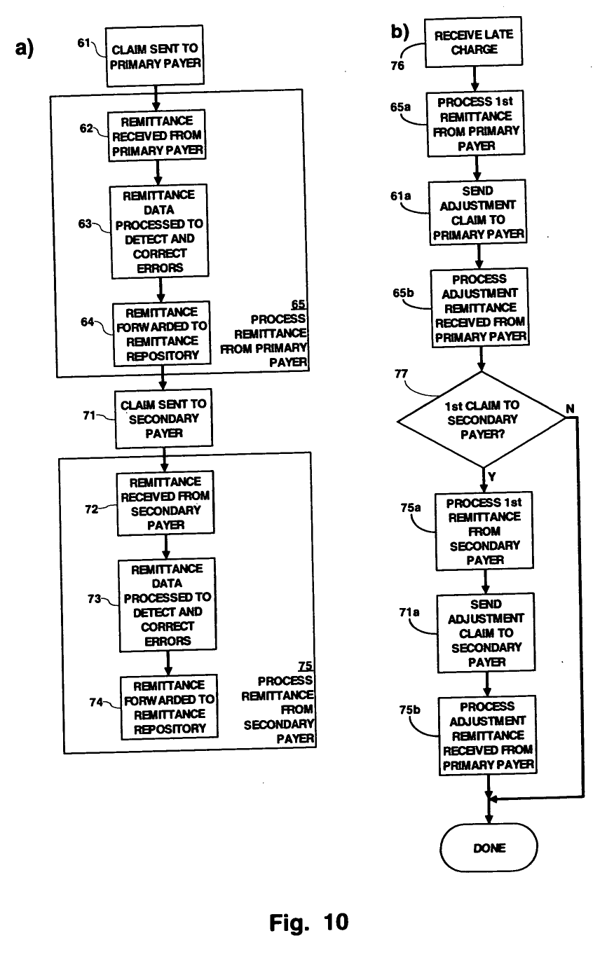

The operation of the automatic secondary billing feature described above may be understood by reference to FIG. 1 and FIG. 10a. FIG. 10a illustrates a flowchart describing the operation of system 1 (FIG. 1) to implement automatic secondary billing. In operation, the patient accounting system 22 generates a claim for the primary third party payer. In step 61, this claim is sent to the primary third party payer. The third party payer processes the claim and submits a payment for the services accompanied by a remittance containing data related to the claim and payment. Among other data elements, the remittance contains a document control number (DCN) which the primary third party payer assigns to the claim. In step 62 this remittance is received by the system 1. In step 63, the rules processor 27 is invoked to check and verify the information in the remittance 4, and to correct erroneous information, if possible, as described above. In step 64, the verified information in the remittance 4 is stored in the remittance repository 5. Steps 62, 63 and 64, designated as combination 65, represent the processing of a remittance 4 received from the primary payer. The patient accounting system 22 updates the patient account in response to the payment represented by the remittance 4 received from the primary payer.

The rules processor 27, during processing of the remittance 4 in step 63, automatically identifies that a secondary third party payer exists. In response, the information in the remittance repository 5 related to the remittance 4 received from the primary third party payer is retrieved by the patient accounting system 22 and used to generate a claim for a secondary third party payer. In step 71, this claim is sent to the secondary third party payer. The secondary third party payer processes the claim and submits a payment for the services, accompanied by a remittance 4 containing data related to the claim and payment. This remittance 4 also contains a DCN, which is different than the DCN from the primary third party payer. In step 72, this remittance 4 is received by the system 1. In step 73, the rules processor 27 is invoked to check and verify the data in the remittance 4, and to correct the data, if possible, as described above. In step 74, the verified information in the remittance 4 is stored in the remittance repository 5. Steps 72, 73, and 74, designated as combination 75, represent the processing of a remittance 4 received from the secondary payer. The patient accounting system 22 updates the patient account in response to the payment represented by the remittance 4 received from the secondary payer. The process of automatically creating claims for subsequent third party payers continues (e.g. for tertiary third party payers, and so forth) until no further third party payers exist. At this point, a bill is automatically created by the patient accounting system 22 for the guarantor.

Claims sometimes need to be adjusted. For example, sometimes a charge related to a patient encounter is received after a claim has been sent to the third party payer(s), generally termed a late charge. For example, a bill from a physician for a consultation or from a laboratory for lab work may be received by the system 1 after a claim has been sent to a third party payer. The late charge must be submitted to the third party payer(s) for reimbursement. Some third party payers require only an additional claim including the late charge. However, typically, a third party payer requires a full record of prior claim submissions and remittances before they consider a revised claim.

FIG. 10b illustrates a flowchart describing the operation of system 1 (FIG. 1) to implement automatic adjustment billing. In FIG. 10b, it is assumed that a first claim has already been sent to the primary third party payer. In step 76, a late charge is received by the system 1, as described above. Step 65a corresponds to the steps in the combination 65 illustrated in FIG. 10a. In step 65a, a first remittance 4 is received from the primary third party payer in response to the first claim, the one without the late charge. The information in the first remittance 4 is processed, verified and corrected, and stored in the remittance repository 5, including the DCN assigned to the claim associated with this remittance 4 by the primary third party payer. The patient accounting system 22 updates the patient account in response to the receipt of the payment represented by the received first remittance 4.

During the processing in step 65a, rules in the rules repository 27 determine that a late charge is pending for this claim. In step 61a, the information in the remittance repository 5 associated with the first remittance 4 is retrieved and used to automatically generate an adjustment claim including all the information in the first claim, the first remittance 4 and, in addition, the late charge. The DCN from the received first remittance 4 is also included in the adjustment claim so that the primary third party payer may match this adjustment claim to the first claim. This adjustment claim is sent to the primary third party payer.

Referring again to FIG. 1, a billing cancellation and repost element 24 is included to cancel a bill or claim, and to forward the information contained in the cancelled bill or claim to the remittance repository 5. The billing cancellation and repost feature applies remittances 4 to modified claims or bills and to claims or bills that are to be resubmitted for payment, as described above. If the remittance 4 associated with the original claim has not yet been received, the DCN is not available because it has not yet been assigned by the third party payer. A validation rule is included in the rules repository 27 that is unique to adjustment claims and prevents the adjustment claim from being submitted to the third party payer prior to the receipt of payment and associated remittance 4 for the first claim.

Referring again to FIG. 10b, the primary third party payer processes the adjustment claim sent in step 61a. Typically, the primary third party payer rescinds the payment associated with the first remittance 4, and sends an adjusted payment for the full amount due in response to the adjustment claim along with an associated remittance 4. The first payment may be rescinded by sending a negative payment for the amount of the first payment amount along with an associated remittance 4. These remittances 4 (the first associated with rescinding the prior payment, and the second associated with sending the full payment) are received by the system 1. In step 65b, the remittances 4 are processed, verified and corrected, and stored in the remittance repository 5. Step 65b also corresponds to the steps in the combination 65 illustrated in FIG. 10a. The patient accounting system 22 updates the patient account in response to the receipt of the payments represented by the received remittances 4.

It is also possible that the late charge was received in step 76 after a first claim is sent to the secondary third party payer in step 71. In step 77, a check is made to determine if a first claim is sent to the secondary third party payer. If not, then no further processing is performed according to FIG. 10b. Instead, the normal claim processing, as illustrated in FIG. 10a, steps 71, 72, 73 and 74 is performed. If, however, a first claim is sent to the secondary third party payer, then the payment and associated remittance 4 from the secondary third party payer is to be received before further processing is performed.

Processing for the secondary third party payer is similar to that for the primary third party payer described above. In step 75a, the first remittance 4 from the secondary third party payer is received, checked and verified, and stored in the remittance repository 5. Step 75a corresponds to the steps in the combination 75 illustrated in FIG. 10a. Rules in the rules repository 27 determine in step 75a that a late charge exists for this claim. An adjustment claim is prepared by the patient accounting system 22, including information from the first and adjustment remittances 4 from the primary third party payer and from the first remittance 4 from the secondary third party payer. The DCN from the first remittance from the secondary third party payer (which is different than the DCN from the primary third party payer) is also included in the adjustment claim for the secondary third party payer, so it may be matched with the first claim. In step 71a, this adjustment claim is sent to the secondary third party payer.

The secondary third party payer processes this adjustment claim. Similarly to the primary third party payer, the secondary third party payer may rescind the first payment and send an adjusted payment for the full amount due in response to the adjustment claim along with associated adjustment remittance 4. Also similarly to the primary third party payer, the secondary third party payer may rescind the first payment by sending a negative payment for the amount of the first amount, along with an associated remittance 4. In step 75b, the system 1 receives the remittances (the first associated with rescinding the prior payment, and the second associated with sending the full payment) and processes them as described above. Step 75b corresponds to the steps in the combination 75 illustrated in FIG. 10a. The information in the supplemental remittance(s) is checked and verified, and stored in the remittance repository 5. The patient accounting system 22 updates the patient account in response to the receipt of the payment(s) represented by the remittances 4.

The processing described above and illustrated in FIG. 10b is repeated for all third party payers. When no further third party payers exist, the guarantor is billed. Because the guarantors are generally individuals, bills for late charges are generally simply additional bills including the guarantor portion of the late charge. However, if the guarantor is a larger entity, such as a self-insured corporation or a trust, then the guarantor also my require a full adjustment bill similar to those required by third party payers. The rules in the rules processor 27 may automatically recognize the type of bill required by the guarantor. The patient accounting system 22 may generate the appropriate type of bill in response to the application of the rules.

In summary, although there is a standard format for individual third party payers to use when electronically communicating remittances 4 to providers, some third party payers use fields in the standardized format in different ways, depending on a large variety of conditions that apply to the remittance 4. A predetermined fixed scheme for receiving remittances 4 which may differ in format, as described above, and revising them to a standard format may need to be completely revised based on the behavior of the third party payer. However, if the field interpretations used in a remittance 4 submitted by a particular payer are encoded into a series of rules stored in the rules repository 27 and applied automatically by the rules processor 17, then these rules may be modified easily to accommodate the various formats used by payers for transmitting payment data.

Although an example of system operation is described that concerns healthcare outpatient remittance processing, this is exemplary only. The system may process outpatient and/or inpatient remittance information, and/or other healthcare related remittances. Similarly, the system is not constrained to examples of this type, but can be used in many other contexts. That is, such a system is able to process remittance 4 information in a business arrangement in which partial payments are made related to a charge, bill, claim or invoice, possibly by multiple parties, and is not limited to the healthcare field. Such a system may process remittances which are not in a standard format, and is able to be modified easily to respond to changes in remittance format by the third party payers.

1. A system for processing remittance information identifying a payment made for provision of healthcare services, comprising:
an interface for receiving data representing information identifying a received remittance;
a repository of remittance information identifying payments made for provision of healthcare services to patients;
a data processor for parsing said received data representing information identifying a received remittance to identify and correct irregularities in said remittance information using predetermined rules, to provide processed remittance information for storage in said remittance repository; and
a command processor for automatically initiating generation of a claim to a third party payer in response to said processed remittance information.

2. A system according to claim 1, wherein said repository accumulates remittance information identifying payments made for provision of healthcare services to patients and for an individual remittance includes an identifier identifying an associated healthcare claim as well as at least one of, (a) an associated patient identifier, (b) associated healthcare encounter identification information, (c) an associated healthcare insurance plan identifier, (d) a third party payer organization identifier and (e) a healthcare provider organization identifier.

3. A system according to claim 1, wherein:
said repository accumulates remittance information identifying payments made for provision of healthcare services to patients and for an individual remittance includes an identifier identifying an associated healthcare claim as well as an associated patient identifier and
said command processor uses said accumulated remittance information for determining whether a second bill is to be generated associated with said healthcare claim.

4. A system according to claim 1, wherein said command processor automatically initiates generation of a message alerting a user to an error condition identified by said data processor in said data representing information identifying said received remittance.

5. A system according to claim 1, wherein said command processor automatically schedules a worker to review said error condition identified by said data processor in said acquired data representing information identifying said received remittance.

6. A system according to claim 1, wherein said data processor derives a rule based on at least one of, (a) documentation and (b) other information provided by third party payer institutions.

7. A system according to claim 1, further comprising:
a rules repository associating a time period of validity with an individual rule; wherein:
said data processor examines said rule validity period and does not apply a rule at a time and date falling outside of said rule validity period.

8. A system according to claim 1, wherein an individual rule of said predetermined rules contains at least one test used to identify a true or false condition and said rules processor initiates a first action in response to a true condition and a second action in response to a false condition.

9. A system according to claim 8, wherein said rule contains a combination of tests with individual test results being logically combined to provide an overall true or false result.

10. A system for processing remittance information identifying a payment made for provision of healthcare services, comprising:
an interface for acquiring data representing information identifying a received remittance;
a repository of accumulated remittance information identifying payments made for provision of healthcare services to patients and including in an individual remittance an identifier identifying an associated healthcare claim as well as an associated patient identifier;
a data processor for parsing said acquired data representing information identifying a received remittance to identify and correct irregularities in said remittance information using predetermined rules, to provide processed remittance information for storage in said remittance repository; and
a command processor for automatically initiating generation of an alert message alerting a user to an error condition identified by said data processor in said acquired data representing information identifying said received remittance.

11. A method for processing remittance information identifying a payment made for provision of healthcare services, comprising the activities of:
acquiring data representing information identifying a received remittance;
accumulating and storing remittance information identifying payments made for provision of healthcare services to patients;
parsing said acquired data representing information identifying a received remittance;
identifying and correcting irregularities in said parsed data representing remittance information using predetermined rules, to provide processed remittance information for storage in said remittance repository; and
automatically initiating generation of a claim to a third party payer in response to said processed remittance information.

12. The method of claim 11 further comprising the activity of identifying an associated healthcare claim as well as at least one of, (a) an associated patient identifier, (b) associated healthcare encounter identification information, (c) an associated healthcare insurance plan identifier, (d) a third party payer organization identifier and (e) a healthcare provider organization identifier.

13. The method of claim 12 further comprising the activity of using said accumulated remittance information for determining whether a second bill is to be generated associated with said healthcare claim.

14. The method of claim 13 further comprising the activity of automatically initiating generation of a message alerting a user to an error condition identified in said acquired data representing information identifying said received remittance.

15. The method of claim 14 further comprising the activity of automatically scheduling a worker to review said error condition identified in said acquired data representing information identifying said received remittance.

16. The method of claim 15 further comprising the activity of deriving a rule based on at least one of, (a) documentation and (b) other information provided by third party payer institutions.

17. The method of claim 16 further comprising the activities of:
associating a time period of validity with an individual rule, and
examining said rule validity period and not applying a rule at a time and date falling outside of said rule validity period.

18. The method of claim 17 further comprising the activities of identifying a true or false condition of an individual rule, and initiating a first action in response to a true condition and a second action in response to a false condition.

19. The method of claim 18 further comprising the activities of:
composing at least one rule so as to contain a combination of tests, and
logically combining individual test results to provide an overall true or false result.

20. The method of claim 19 further comprising the activities of inspecting substantially all stored remittance information, and identifying inspected remittances that are candidates for use by other applications.
